(19) United States
(12) Patent Application Publication
(10) Pub. No.: US 2026/0333467 A1
(43) Pub. Date: Oct. 22, 2026

(54) MANAGING TIMING OF ELECTRONIC SHELF LABEL CONNECTIONS

(71) Applicant: QUALCOMM Incorporated, San Diego, CA (US)

(72) Inventors: Zhengjinyang JIANG, Shanghai (CN); Jie ZHANG, Shanghai (CN); Nicolas GRAUBE, Cambridge (GB); Zaiyong CHEN, Shanghai (CN); Zhaoming YANG, Shanghai (CN); Liuliu ZHAO, Shanghai (CN); Zhuxian GU, Suzhou (CN); Xiuzhuo SHANG, Shanghai (CN)

(21) Appl. No.: 19/119,343

(22) PCT Filed: Nov. 11, 2022
(86) PCT No.: PCT/CN2022/131305

§ 371 Date: Apr. 8, 2025

(51) Int. Cl. H04W 76/10; H04W 4/35

(52) U.S. Cl. CPC H04W 76/10; H04W 4/35

(57) ABSTRACT

Various aspects include methods that may be performed by access points (APs) for managing timing of establishing communication links with electronic shelf labels (ESLs). An AP may perform communication operations with a first ESL using a first connection during a first connection duration, and transmit a connection request to a second ESL prior to completing the communication operations with the first ESL during the first connection duration. The AP may establish a second connection with a second ESL based on the connection request sent to the second ESL. The AP may establish the second connection with the second ESL in a second connection duration that begins at or soon after the end of the first connection duration.

### BACKGROUND

Electronic Shelf Labels (ESLs) are devices that can be used in supermarkets, supply stores, warehouses, and the like to monitor and control inventory tracking, product mapping, price change rollouts, and the customer experience generally. ESLs may communicate with a network access point (AP) using an energy-efficient, short range wireless communication protocol such as Bluetooth Low Energy.

An AP may broadcast periodic advertisement (PA) messages at substantially regular intervals. Such PA messages may include operational code to access onboarding ESLs, or may serve as synchronization signals for use by ESLs. The connection between the AP and ESLs is torn down once a data download is completed. To perform a subsequent communication activity, a reconnection is required, and the AP may send an AUX_CONNECT_REQ (ACRQ) message to the ESL. In operation, an AP may communicate with hundreds or thousands of ESLs.

### SUMMARY

Various aspects of the present disclosure include methods and access points (APs) configured to perform the methods for managing timing of establishing connections, such as Asynchronous Connection-less (ACL) communication links, with ESLs. Various aspects may include performing communication operations with a first electronic shelf label (ESL) using a first connection during a first connection duration, sending a connection request to a second ESL prior to completing the communication operations with the first ESL during the first connection duration, and establishing a second connection with a second ESL based on the connection request sent to the second ESL.

In some aspects, establishing the second connection with the second ESL based on the connection request sent to the second ESL may include establishing the second connection with the second ESL in a second connection duration that begins at an end of the first connection duration. In some aspects, transmitting the connection request to the second ESL prior to completing the communication operations with the first ESL during the first connection duration may include transmitting the connection request to the second ESL in a subevent during the first connection duration in which the second ESL receives a synchronization signal from the AP. In some aspects, transmitting the connection request to the second ESL prior to completing the first connection duration with the first ESL may include transmitting the connection request to the second ESL at an offset time prior to completion of the first connection, in which the offset time may include a time interval based on a wake-up time period of the second ESL.

In some aspects, establishing the second connection with the second ESL based on the connection request sent to the second ESL may include receiving a connection response from the second ESL during the first connection duration based on the connection request sent to the second ESL, and establishing the second connection with the second ESL at an end of the first connection duration based on the connection response received from the second ESL. Some aspects may include transmitting a connection request to a third ESL prior to completion of the first connection duration with the first ESL in response to no connection response being received from the second ESL, and establishing the second connection with the third ESL based on a connection response received from the third ESL in response to the connection request transmitted to the third ESL.

Some aspects may include transmitting data to the second ESL at the beginning of a second connection duration. Some aspects may include transmitting data to the second ESL at an end of a wake-up time period of the second ESL. In some aspects, establishing the second connection with the second ESL based on the connection request sent to the second ESL may include transmitting first data to the second ESL prior to an end of the first connection duration, and transmitting second data to the second ESL in a second connection duration that begins at the end of the first connection duration. In some aspects, transmitting the first data to the second ESL prior to the end of the first connection duration may include transmitting the first data to the second ESL after a wake-up time period of the second ESL that ends prior to the end of the first connection duration.

Further aspects include an AP configured with a processor for performing one or more operations of any of the methods summarized above. Further aspects include an AP having a processor configured to perform one or more operations of any of the methods summarized above. Further aspects may include a non-transitory processor-readable storage medium having stored thereon processor-executable instructions configured to cause a processor of an AP to perform operations of any of the methods summarized above. Further aspects include an AP having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram illustrating an ESL system suitable for implementing any of various embodiments.

FIG. 1B is a system block diagram illustrating an example configuration of signal communications in an ESL system implementing some embodiments.

FIG. 2 is a component block diagram illustrating an example computing and wireless modem system on a chip suitable for use in a computing device implementing any of various embodiments.

FIGS. 3A-3C are timelines illustrating aspects of methods for managing timing of establishing connections with ESLs according to various embodiments.

FIG. 4 is a process flow diagram of a method of managing timing of establishing connections with ESLs according to various embodiments.

FIGS. 5A-5E are process flow diagrams of operations that may be performed as part of the method of managing timing of establishing connections with ESLs according to various embodiments.

FIG. 6 is a component block diagram of an ESL suitable for use with various embodiments

FIG. 7 is a component block diagram of an access point suitable for use with various embodiments.

FIG. 8 is a component block diagram of a server suitable for use with various embodiments.

FIG. 9 is a component block diagram of a user mobile device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and access points (APs) configured to implement the methods, for enabling an AP to manage the establishment of connections, such as Asynchronous Connection-oriented Logical transport (ACL) communication links, with electronic shelf labels (ESLs) to reduce a time gap between communication links established between the AP and ESLs. Various embodiments improve the operation of APs, ESLs, and ESL systems by reducing a time gap between ACL communication link, thereby increasing an overall data throughput from the AP to ESLs in the ESL system.

The term “electronic shelf label” or “ESL” is used herein to refer to a computing device with an electronic display that can be placed or secured to, in, on, or near store shelves. The ESL may include a processor, memory, a display, and one or more wireless transceivers, in which the processor may be programmed or provided data to render images (e.g., text, bar codes, trademarks, etc.) that communicate information (e.g., to people) regarding products near the device. In some aspects, ESLs may be battery powered to enable placement on or near products without the need for a power infrastructure. Alternatively, an ESL may be supplied power by the shelve to which the ESL is secured.

ESLs may be programmed, reprogrammed or updated (e.g., via onboarding messages transmitted by the AP) so that product information rendered on the display can be updated at any time. Thus, the ESLs may serve the function of paper shelf labels with the added efficiency of enabling product information (e.g., prices) to be changed without physically replacing shelf labels.

While various embodiments are described with reference to ESLs being placed on shelves within a store, ESLs may also be positioned on large goods (e.g., furniture, appliances, etc.), on or near stands or stacks of goods, on pallets on which products are positioned, and other locations where products may be offered for sale or selection. Further, ESLs may be used for other purposes, such as placed on doors to indicate vacant or occupied status. Use of the term “shelf” (or as signified by the “S” in ESL) is not intended to limit the claims to labels that are only positioned on shelves.

In some configurations, ESLs may include extended reality (XR) tags that may send signals to an XR device (e.g., smart glasses, display screen of a smart phone, or other device configured to provide extended reality displays) configured to cause the XR device to generate a visible display. The content visible on a display of an XR device based on signals of the XR tag may be viewable while a store picker or other user looks at (i.e., orients the XR glasses in the direction of) the ESL. For example, an XR device directed at a bag of potato chips may display product related information such as “Lays Potato Chips $1.99.” The information provided by the XR tags may be the same or different than what is viewable in the ESL to normal users that do not use XR glasses or another XR device. In some embodiments, the ESL may not include a display, but rather may operate as an XR anchor to send operation messages and other information to XR devices. For example, when a user wearing XR glasses looks at a product (e.g., Lays Potato Chips), a small window may appear on a user interface (UI) showing product information (e.g., “Lays Potato Chips $1.99”).

As used herein, the term “computing device” refers to an electronic device equipped with at least a processor, memory, and a device for presenting output such as a location of an object or objects of interest. In some embodiments, a computing device may include wireless communication devices such as a transceiver and antenna configured to communicate with wireless communication networks. A computing device may include any one or all of an outer smart device, a base-band, smart watches, smart rings, smart necklaces, smart glasses, smart contact lenses, contactless sleep tracking devices, smart furniture such as a smart bed or smart sofa, smart exercise equipment, Internet of Things (IoT) devices, augmented/virtual reality devices, cellular telephones, smartphones, portable computing devices, personal or mobile multimedia players, laptop computers, tablet computers, 2-in-1 laptop/table computers, smart books, ultrabooks, multimedia Internet-enabled cellular telephones, entertainment devices (e.g., wireless gaming controllers, music and video players, satellite radios, etc.), and similar electronic devices that include a memory, wireless communication components and a programmable processor. In some embodiments, a computing device may be wearable device by a person. As used herein, the term “smart” in conjunction with a device, refers to a device that includes a processor for automatic operation, for collecting and/or processing of data, and/or may be programmed to perform all or a portion of the operations described with regard to various embodiments.

The term “mobile wireless device” is used herein to refer to computing devices that include any one or all of customer smartphones, a store picker's mobile wireless device, cellular telephones, portable computing devices, laptop computers, tablet computers, smartbooks, ultrabooks, palmtop computers, multimedia Internet-enabled cellular telephones, wearable devices including smart watches, smart clothing, smart glasses, earbuds, headphones, smart wrist bands, and similar electronic devices that include a memory, wireless communication components and a programmable processor.

The term “user mobile device” is used to refer to a mobile wireless device that is specifically configured to support users within a store, such as the store picker job functioning within a store picker system according to various embodiments. A store picker wireless device may include a processor, memory, an electronic display, wireless transceiver(s) including a Bluetooth transceiver and Wi-Fi transceiver, a barcode scanner, and other components useful for store picking.

The term “store” when used herein with reference to a physical place refers to a wholesale, retail, or other building in which products are stored for sale and/or distribution. A store may include (but is not limited to) a warehouse, fulfillment center, department store, specialty store, market, supermarket, hypermarket, convenience store, discount store, super store, and/or other storage facility.

The term “product” is used herein to refer to one or more items, articles, merchandise, or substances that are collected, refined, manufactured, and/or assembled and are maintained in a store or the like, such as products that may be identified on a shopping list and picked by store pickers.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single computing device. The proximity of the SOCs facilitates high speed communications and the sharing of memory and resources.

Typically, connections between an AP and an ESL are established before the ESL is associated with the AP (e.g., for the performance of onboarding operations) or for performing synchronization or other operations. For example, when the AP needs to perform a Generic ATTribute (GATT) operation or data transfer operation (OTS), the AP and the ESL may establish a connection (which may require some brief negotiation between the AP and the ESL) and transfer data. In some embodiments, an AP may broadcast periodic advertisement (PA) messages at substantially regular intervals. Such PA messages may include operational code to access onboarded ESLs (e.g., synchronized or associated with an AP), or may serve as synchronization signals for use by ESLs.

At the completion of onboarding, synchronization, or other operations, the AP may drop the connection and reallocate the communication resources for communication with another ESL, while the previous ESL may enter a low-power or sleep mode. For example, the connection between the AP and the ESL may be torn down (e.g., allocated resources are released) once a data download is completed. To perform a subsequent communication activity, a reconnection is required.

In some embodiments, the AP may send an AUX_CONNECT_REQ (ACRQ) message to the ESL, as provided in the Periodic Advertising with Responses (PAwR) specification, sometimes referred to as a “fast connect” mechanism for establishing ACL communication links between APs and ESLs. The fast connect reconnection mechanism includes a Host Controller Interface (HCI) command to initiate a Create Connection request based on a PA train. The Controller entity may transmit an auxiliary connection request (ACRQ) message (e.g., an AUX_CONNECT_REQ Bluetooth message) in a subevent slot of the periodic advertising train in which an auxiliary synchronization indication (AUX_SYNC_IND) message is being transmitted periodically. The AUX_SYNC_IND message may function as a synchronization message between the AP and the ESLs.

In operation, an AP may communicate with hundreds or thousands of ESLs. An AP may support a limited number of connections with ESLs. Conventionally, an AP may establish connections serially, creating a new connection after an existing connection is completed. However, various factors may cause a time gap between two connections (e.g., with ESLs). First, ESLs typically transition from a low-power operating mode or a sleep operating mode to a full power or “awake” operating mode after receiving an ACRQ from the AP. During time required for an ESL to transition from low-power operating mode or to full power mode, the ESL may be unable or unprepared to receive communications from the AP. (As a non-limiting example, such an ESL operating mode transition may require up to 60 milliseconds). Second, an ESL (or group of ESLs) may not be available at the beginning of every PA subevent to synchronize with the AP. For example, ESLs may be arranged (e.g., organized or associated) as groups, and each group may have its own PA. Communication resources that are released at a particular point in time may be the only available resources for a PA associated with one or more ESLs of a group. In some cases, after completing a first connection with a first ESL, an AP may wait two or more subevent intervals until a second ESL is available to receive a transmission of an ACRQ. Third, communication delays may be caused by signal interference that may prevent an ESL from receiving an ACRQ, and/or may prevent an AP from receiving a response from the ESL, such as an auxiliary (AUX) connect response (ACRP) message.

The presence of time gaps between two connections with ESLs may delay the transfer of data to or from ESLs. In systems in which hundreds or even thousands of ESLs are deployed, time gaps between connections may aggregate to substantial delays in data transfer and other operations. However, conventional attempts to reduce a gap between ESL connections tend to degrade the operation of ESLs or are impractical for real-world operations. For example, configuring ESLs to operate in full power mode at all times may reduce (or eliminate) a transition time from low-power sleep mode, but may rapidly consume ESL's limited batteries. As another example, while deploying a very large number of ESLs may provide an ESL that is available at every PA sub event time, increasing the number of ESLs increases the organizational complexity required to provide well distributed sub event groups (e.g., a grouping strategy for organizing ESLs into groups).

Various embodiments include methods, and APs configured to implement the methods, for managing timing of ESL communication links. In various embodiments, the AP may be configured to predict when communication operations during a first connection with an ESL will be completed, and perform operations to reduce a time gap between the first connection and a subsequent second connection with a second ESL. In some embodiments, the AP may determine the completion time of the first connection in terms of 12.5 millisecond frames. In various embodiments, scheduling logic of the AP may be configured to reduce time gaps between ESL communication links (such as ACL communication links) by initiating the process of establishing a communication link with a second ESL before a communication link with a first ESL is terminated. In various embodiments, while an AP is performing communication operations with a first ESL using a first connection during a first connection duration, the AP may transmit a connection request to a second ESL prior to completing the communication operations with the first ESL during the first connection duration. The AP may then establish a second connection with a second ESL based on the connection request sent to the second ESL. In some embodiments, the AP may establish the second connection with the second ESL in a second connection duration that begins at the end of the first connection duration, or substantially at the end of the first connection duration, such as within a short time after the end of the first connection duration, for example, within one frame or frame duration (e.g., each frame having a duration of 12.5 ms), or within a duration of milliseconds (e.g., within 12.5 ms). The phrase “at an end of the first connection” or “at the end of the first connection” includes “substantially at the end of the first connection” in its meaning. In some embodiments, the AP may transmit the connection request to the second ESL in a subevent during the first connection duration in which the second ESL receives a synchronization signal from the AP.

In some embodiments, the AP may transmit the connection request to the second ESL at an offset time prior to the completion of the first connection (i.e., a time that is offset from the completion time of the first connection). In some embodiments, the offset time may be a time interval based on a wake-up time period of the second ESL. As used herein, a “wake-up time period” refers to an amount of time required for the second ESL to be able to receive communications from the AP (as one example, an amount of time required for the second ESL to transition operating modes to be able to communicate with the AP). In such embodiments, the AP may determine the time at which the first connection duration will end. The AP may determine a connection request transmit time that is prior to the end of the first connection based on the offset time, such that the connection request transmit time is during the first connection duration. The AP may transmit the connection request at the determined connection request transmit time during the first connection duration.

In some embodiments, the AP may receive a connection response from the second ESL during the first connection duration based on the connection request sent to the second ESL. In such embodiments, the AP may establish the second connection with the second ESL at the end of the first connection duration based on the connection response received from the second ESL.

In some embodiments, if the AP does not receive a connection response from the ESL, the AP may transmit the connection request to the another ESL (a third ESL) prior to completing the first connection duration with the first ESL. For example, the second ESL may not receive the connection request from the AP, or the AP may not receive a response or acknowledgement from the second ESL. However, the AP may have one or more opportunities to transmit a connection request to another ESL (a third ESL), because the AP transmitted the initial connection request sufficiently before the end of the first connection duration. The AP may establish the second connection with the third ESL based on a connection response received from the ESL in response to the connection request transmitted to the third ESL.

In various embodiments, the AP may transmit data to the second ESL at the beginning of the second connection duration. In some embodiments, the AP may transmit data to the second ESL at the end of a wake-up time period of the second ESL. In some embodiments, the wake-up period of the ESL may end before the end of the first connection duration. In such embodiments, the AP may transmit first data to the second ESL prior to the end of the first connection duration, and may transmit second data to the second ESL in a second connection duration that begins at the end of the first connection duration. In some embodiments, the AP may transmit the first data to the second ESL at the end a wake-up time period of the second ESL, in which the wake-up time period ends prior to the end of the first connection duration.

Various embodiments improve the operation of ESLs, APs, and ESL systems by enabling an AP to manage the establishment of connections (communication links) with ESLs to a time gap between the connections established with different ESLs. Various embodiments improve the operation of APs, ESLs, and ESL systems by reducing the time gap between ACL communication links, thereby increasing the overall data throughput that can be achieved from the AP to ESLs in ESL systems.

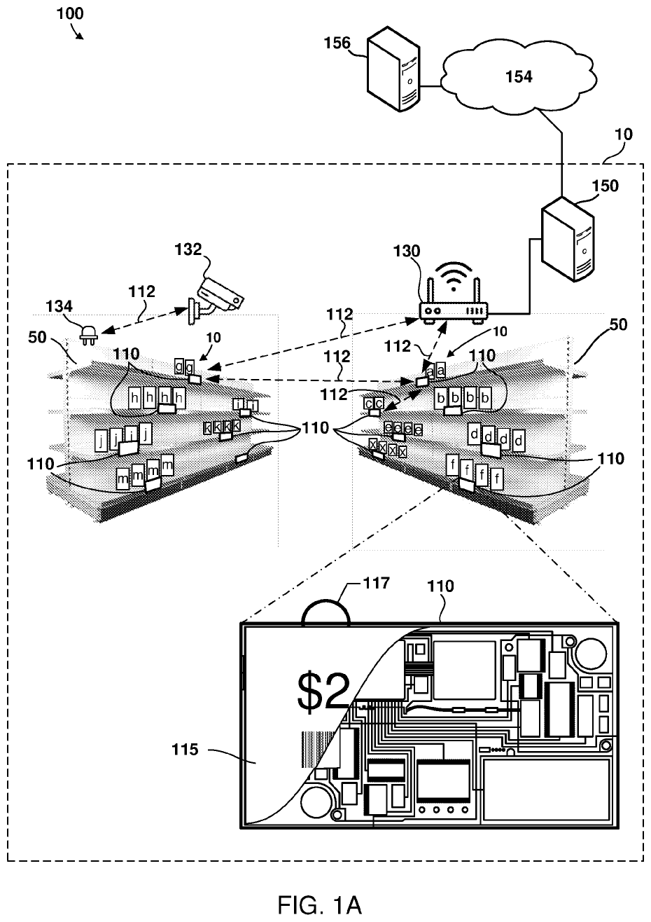

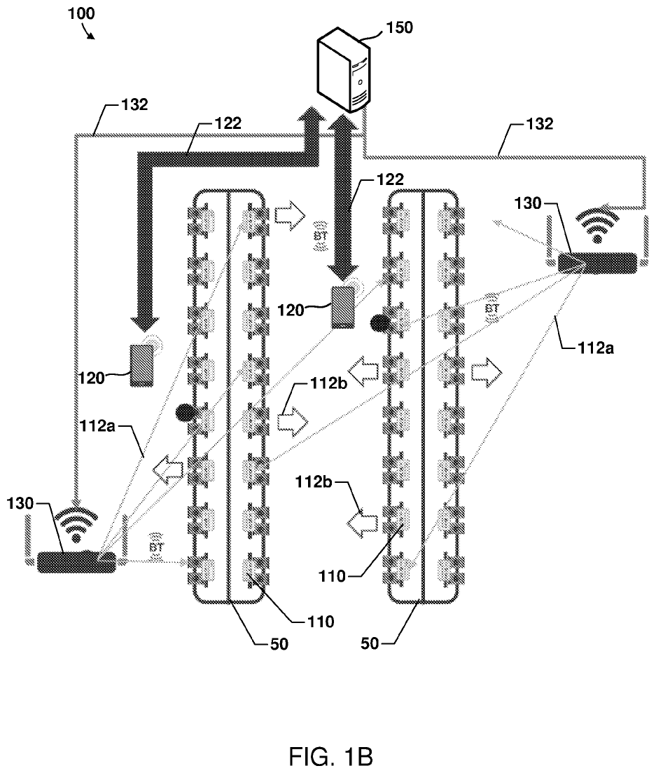

FIG. 1A is a component block diagram of an ESL system 100 suitable for implementing various embodiments. System elements that may be deployed within a given store 10 may include a plurality of ESLs 110 deployed on shelves 50 that are configured to communicate with a number of APs 130 that are connected to a store management entity server 150.

ESLs 110 may be positioned on shelves 50 associated with products (labeled a, b, c, d, e, f, g, h, i, j, k, and m). Each ESL 110 may include a display 115 on which is presented product name, product codes, prices, stocking information, barcodes, and the like. Some ESLs 110 may further include an illuminator 117, such as a light emitting diode (LED) or other visible light generating devices configured to illuminate to draw the attention of a store picker and/or other customers as described herein. In some embodiments, some ESLs 110 may include a speaker or vibration-generating device to generate visual, audible, and/or tactile notifications. Each ESL 110 may include a beacon transmitter and be configured to detect neighboring ESLs, such as via Bluetooth or Bluetooth Low Energy (BLE) signals. Some ESLs 110 may include one or more sensors, such as (but not limited to) a proximity sensor to detect when an individual is standing near the ESL 110, a microphone for monitoring ambient noise as well as receiving speech from a customer or store picker in some embodiments, and/or the like. In some embodiments, various ESLs deployed in the ESL system 100 may be configured and/or equipped with different capabilities or with the same capabilities.

The ESLs 110 may be configured to receive communications from the store management entity server 150, such as through wireless communication links 112 that may be relayed via the APs 130. Thus, the store management entity server 150 may configure each ESL 110 with product information to be displayed, as well as duty cycles for when the ESL should activate to receive signals and transmit wireless beacons. The store management entity server 150 may control the periodicity of ESL duty cycles in order to minimize battery drain/usage, so as to extend the operating life, while ensuring the ESL is responsive to customers and store pickers, such as by increasing the duty cycle when individuals are within proximity of an ESL (e.g., close enough to see and/or read a display of the ESL). Further, management entity server 150 may configure ESLs 110 to generate an appropriate indication (e.g., visual, audible, and/or tactile indications) at an appropriate time, such as when an ESL is associated with a product that appears on a shopping list of a user that is nearby (e.g., within a predetermined distance). In various embodiments, the store management entity server 150 may be located within or near the store, or located remotely and accessed via a communication network 154.

ESLs 110 may be configured to exchange wireless communications with each other through wireless links 112, such as wireless beacons or tones, for various purposes, including in particular for determining the relative and actual location of the ESLs on shelves 50 and with respect to one another as described herein.

In some embodiments, the ESL system 100 deployed within a store 10 may also include other mechanisms for determining the precise location of ESLs and individual store pickers or customers. For example, in some embodiments, the system may include ultrasonic emitters 134 that may be configured to periodically or episodically admit ultrasonic tones (for example) that can be received by a microphone on each ESL 110 for purposes of determining relative location of each ESL via sound ranging processes. As another example, in some embodiment, the system may include infrared emitters that may be configured to emit an infrared light beam that can be received by a photo-detector on each ESL for the purpose of determining relative location via IR ranging techniques. As another example, the system may include cameras 132 coupled to the store management entity server 150 that may be positioned to provide imaging of ESLs 110 as well as individuals (e.g., store pickers, customers, and/or other individuals). Image data received from such cameras 132 may be used by the store management entity server 150 to determining the location of each ESL and individuals. In some embodiments, the camera 132 may be positioned on the shelves so as to view products as well as individuals near the products. In some embodiments, ESLs 110 may include a camera and be configured to transmit images to the store management entity server 150 via a wireless link 112 with an AP 130.

The store management entity server 150 may be configured with detailed maps of the locations of products within the store, referred to as a planogram, that is correlated or calibrated to an indoor location system, such as supported by the ESLs 110 as described. The store management entity server 150 may also incorporate information from an inventory system that keeps track of the products stocks in order to avoid sending a store picker to the location of a product that is out of stock.

The APs 130 may be configured to communicate with ESLs 110 to provide communications with the store management entity server 150. In some embodiments, APs may be configured with cameras or be coupled to cameras to provide visual images of ESLs as well as customers and store pickers to provide more precise location information as described herein. APs 130 may also be configured with antenna arrays that enable determining the angle of arrival (AOA) of wireless communications, providing further localization information to the store management entity server 150.

The user mobile devices 120 may be any form of mobile device, not just the smart phone as illustrated. For example, in addition to being personal mobile devices, the mobile devices 120 that may be used in the system 100 may include smart watches, body cams, augmented reality glasses (e.g., smart glasses), and facility-specific or enterprise-specific handheld devices that are configured specifically for store pickers.

FIG. 1B illustrates further details of communication links that may be utilized in the ESL system 100 according to some embodiments. With reference to FIGS. 1A and 1B, ESLs 110 may be configured to communicate with APs 130 via wireless links 112a, such as Bluetooth, and to exchange wireless signals with other ESLs 110 via wireless links 112b. For example, ESLs 110 may transmit certain BLE signals 112a, such ESL advertisements that are configured to be received by a nearby AP 130 and used to onboard the ESL 110. In addition, ESLs 110 on opposite sides of an aisle (i.e., the separation between two shelves 50) may transmit certain BLE signals 112b that are configured to be received by a nearby ESL 110 and used for the purposes of determining relative positions of the respective devices. BLE signals 112a, 112b may be broadcast at a set or select power level, enabling separation distances to be estimated based upon the measured received signal strength indicator (RSSI) of the signals received by other ESLs 110. APs 130 may be coupled to the store management entity server 150 via wired connections 132.

User mobile devices 120, which may be held, carried, or otherwise associated with a store picker or customer may receive a beacon signal, such as through a wireless link from ESLs and communicate with the store management entity server 150 via wireless communications, such as BLE, Wi-Fi, or cellular communications of various types. The APs 130 may be configured to communicate with user mobile devices 120 to provide communications with the store management entity server 150. The APs 130 may also provide user mobile devices 120 with access to external communication networks, such as the communication network 154, to enable customers to access remote servers 156, such as to comparison shop, research products, and otherwise provide Internet access support.

User mobile devices 120 used by store pickers may receive beacon signals (e.g., BT or BLE) from each of the ESLs 110 but also communicate received beacon information (e.g., identity code and RSS I information) directly to the store management entity server 150 via separate communications 122. Such separate communications 122 may be via Wi-Fi communications (e.g., via APs 130) or via cellular data networks (e.g., fifth generation (5G) cellular networks).

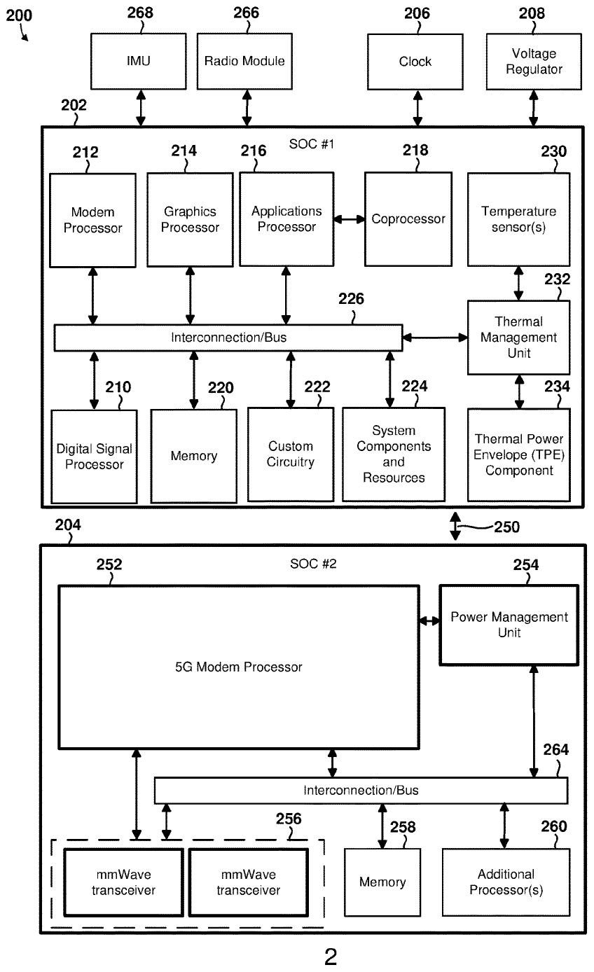

FIG. 2 is a component block diagram illustrating a non-limiting example of a computing and wireless modem system 200 suitable for use in a computing device, such as an AP or some ESLs, for implementing any of various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, a radio module 266 configured to send and receive wireless communications, including BLE messages, via an antenna (not shown and an inertial measurement unit) (IMU) 268. When the computing system 200 is used in Aps or ESLs, the radio module 266 may be configured to broadcast BLE beacons as described herein. In some implementations, the first SOC 202 may operate as central processing unit (CPU) of the user mobile device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 38 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a user mobile device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. Various processors 210, 212, 214, 216, 218, 252, 260, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

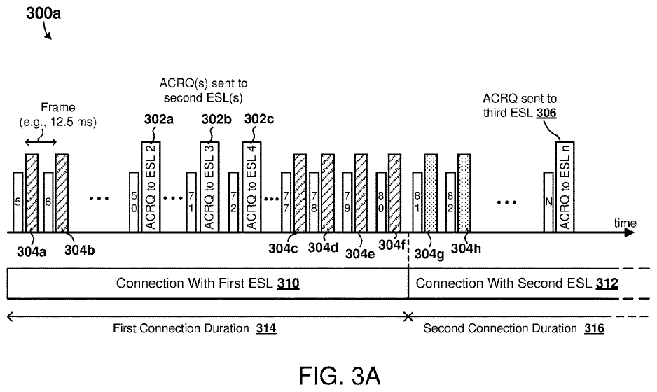

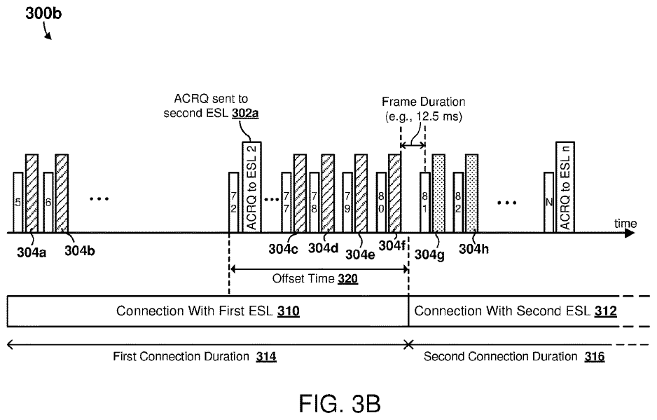

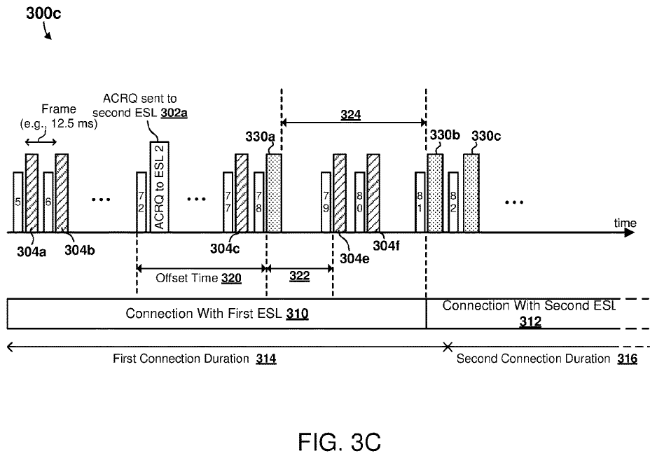

FIG. 3A is a timeline illustrating aspects of a method 300a for managing timing of establishing connections with ESLs according to some embodiments. With reference to FIGS. 1A-3A, an AP may perform communication operations with a first ESL using a first connection 310 during a first connection duration 314. As an example, the first connection duration 310 illustrated in FIG. 3A lasts from 5 to subevent 80. The AP may transmit data 304a, 304b, 304c, 304d, 304e, and 304f to the first ESL during different subevents. For example, the AP may transmit data 304a during subevent 5, data 304b during subevent 6, data 304c during subevent 77, data 304d during subevent 78, data 304e during subevent 79, and data 304f during subevent 80. In some embodiments, a delta between data 304a and 304b, and between other adjacent data transmissions, such as between 304c and 304d, etc., may be substantially equal to a group length. In various embodiments, a “group” is a logical concept attached to or associated with a subframe. In some embodiments, there may be 128*12.5 ms in a 1.6 s frame, which may encompass 128 groups. An ESL may belong to (be associated with) at least one group. In some embodiments, an ESL may “wake up” (i.e., provide power to RF components and/or circuitry) for the groups and associated time periods with which the ESL is associated.

In some embodiments, after the AP establishes the first connection 310 with the first ESL (e.g., starting at subevent 5), and prior to completion of the connection with the first ESL 310, the AP may transmit a connection request (ACRQ) to one or more second ESLs during the first connection duration. If the AP does not receive an acknowledgement (e.g., an ACRP) from an ESL, the AP may select another ESL and transmit an ACRQ to the selected next ESL.

For example, the AP may transmit ACRQ 302a to ESL 2 in subevent 50. If the AP does not receive an acknowledgement from ESL 2 by a deadline, the AP may select ESL 3 and transmit ACRQ 302b to ESL 3 in subevent 71. If the AP does not receive an acknowledgement from ESL 3 by a deadline, the AP may select ESL 4 and transmit ACRQ 302c to ESL 4 in subevent 72. In the example illustrated in FIG. 3A, the AP may select second ESL candidates and transmit an ACRO to the selected ESL candidate in any subevent from subevent 7 through subevent 72. In some embodiments, the AP may transmit the one or more ACRQs 302a, 302b, 302c, etc. during subevents in which the AP may otherwise transmit a periodic advertisement for synchronization with one or more other ESLs.

In response to receiving a response or an acknowledgement (e.g., an ACRP) from an ESL, the AP may establish a connection for the second ESL 312 with the ESL that sent the response. In some embodiments, the AP may establish the connection with the second ESL 312 at the end of the first connection 310. In some embodiments, the AP may establish the second connection 312 for a second connection duration 316 that begins at the end (or substantially near or just after the end) of the first connection duration 314. For example, the AP may establish the second connection 312 within a frame duration (and/or within a 12.5 millisecond duration) between the end of data transmission 304f (in subevent 80) and the beginning of data transmission 304g (in subevent 81). Configuring the AP to transmit the ACRQs 302a-302c to the second ESL(s) during the first connection duration 314 may reduce a time gap between the first connection 310 with the first ESL in the first connection duration 314 and the second connection 312 with the second ESL in the second connection duration 316.

In some embodiments, during the second connection duration 316, the AP may send a connection request 306 (e.g., ACRQ) to a third ESL, to initiate a process for establishing a third connection with the third ESL at the end of the second connection duration 316.

FIG. 3B is a timeline illustrating aspects of a method 300b for managing timing of establishing connections with ESLs according to some embodiments. With reference to FIGS. 1A-3B, the AP may transmit data to the second ESL at the beginning of the second connection duration 312. In some embodiments, the AP may transmit data to the second ESL at the end of a wake-up time period of the second ESL.

In some embodiments, the AP may determine an offset time 320. In some embodiments, the offset time 320 may represent an amount of time required for the ESL to be ready to receive data from the AP. For example, the offset time 320 may be a time interval that is based on the wake-up time period that the second ESL requires to transition from a sleep operation mode or low-power operation mode in which it is currently operating to a full-power operation mode in which the second ESL can communicate with the AP. In some embodiments, the AP may determine the offset time period as WinOffset=Z*12.5 ms+1.25 ms, in which WinOffset represents the offset time, 12.5 ms represents a frame duration during a connection duration, Z represents a number of frames, and 1.25 ms represents 10 divisions of a sub-frame. For example, if an ESL requires 5 frames to be ready to receive data from the AP (i.e., Z=5), then WinOffset=5 frames*12.3 ms+1.25 ms=63.75 ms. In this example, WinOffset would accommodate a second ESL transition time of approximately 60 milliseconds. In this example, the AP transmits a connection request 302 (e.g., an ACRQ) to the second ESL during subevent 72, and the AP receives a connection response from the second ESL during subevent 72.

In some embodiments, the AP may send data to the second ESL at the end of the offset time 320. In some embodiments, the end of the offset time 320 may represent a first opportunity in which the second ESL is ready to receive data from the AP (for example, after completing an operating state transition from a low-power mode to full-power mode). In this manner, the AP may delay sending or wait to send data to the second ESL until a time in which the second ESL is capable of receiving the data. During the offset time 320, the AP may maintain the first connection 310 with the first ESL. Because the second ESL completes the operating mode transition to full power mode during the first connection duration 314, the AP may establish the second connection 312 with the second ESL in the second connection duration 316 that begins at or very soon after the end of the first connection duration 314. In some embodiments, the end of the first connection duration 314 may be a time at which the AP ends or completes communications with the first ESL.

In some embodiments, the AP may configure the offset time 320 to end at the beginning of the second connection duration 316 at which the second connection 312 with the second ESL begins. In some embodiments, the AP may transmit the connection request to the second ESL at the beginning of the offset time 320. Transmitting the connection request to the second ESL at the beginning of the offset time 320 may enable the second ESL to complete the operating mode transition to full power by or at the end of the first connection duration 314, so that the AP may establish the second connection 312 with the second ESL at the beginning of the second interval 316, which may begin at the end of the first connection duration 314. In this manner, the AP may manage communications with the second ESL so that the AP may establish the second connection “just-in-time” at the end of the first connection duration 314 at which the first connection 310 with the first ESL is completed.

FIG. 3C is a timeline illustrating aspects of a method 300c for managing timing of establishing communication links with ESLs according to various embodiments. With reference to FIGS. 1A-3C, in some circumstances, the AP may be unable to establish a second connection with the second ESL at a time that the AP initially planned, because communication with a first ESL (i.e., a connection with the first ESL) does not complete when expected or planned by the AP, perhaps due to less-than-ideal RF communication conditions causing the communications to take longer than initially planned. As another example, the AP may be unable to receive a connection response after sending only one connection request. For example, the AP and/or ESLs may be deployed in an environment not conducive to clear RF communications, or the AP and/or ESLs may experience signal coexistence or interference from other signals, such as Wi-Fi signals.

For example, the first connection duration 314 of the first connection 310 with the first ESL may extend beyond the end of the offset time 320. If the AP is operating in a bad RF environment, such as due to coexistence with other RF signals (e.g., Wi-Fi) or other RF noise, the AP may send multiple connection requests to ESLs before receiving a connection response, and the end time of the connection with the first ESL 310 may be later than the end of the offset time 320. In such a case, the AP may send first data 330a to the second ESL before the connection with the first ESL 310 is complete, and then the AP may delay sending second data 330b until after completion of the connection with the first ESL 310.

In some embodiments, the AP may transmit a connection request 302a (e.g., an ACRQ) to the second ESL, and the AP may receive a connection response (e.g., an ACRP) from the second ESL. In such embodiments, the AP may transmit first data 330a to the second ESL during the first connection duration 314 of the first connection 310 with the first ESL (if communication link resources are available). For example, the AP may transmit the first data 330a to the second ESL after the offset time 320 during a first data transmission period 322. The AP may then delay transmission of second data 330b until after the beginning of the second connection duration 316. In some embodiments, the AP may delay transmission of the second data 330b for a second data delay period 324.

In some embodiments, to transmit the first data 330a to the second ESL, the AP may use communication resource(s) and/or transmission opportunities that the AP could otherwise use for a transmission to the first ESL. In such embodiments, after the first data transmission period 322, the AP may resume transmitting data to the first ESL for the remainder of the first connection duration 314. The AP may transmit the second data 330b at the beginning of the second connection duration 316. In some embodiments, the AP may employ a delay mechanism such as a supervision timeout or another suitable mechanism that enables the AP to delay sending the second data 330b to the second ESL. In some embodiments, the delay mechanism may enable the AP to delay sending the second data 330b, 330c for up to a threshold duration (e.g., up to 10 seconds). In this manner, the AP may manage the timing of communications with ESLs in suboptimal RF environments.

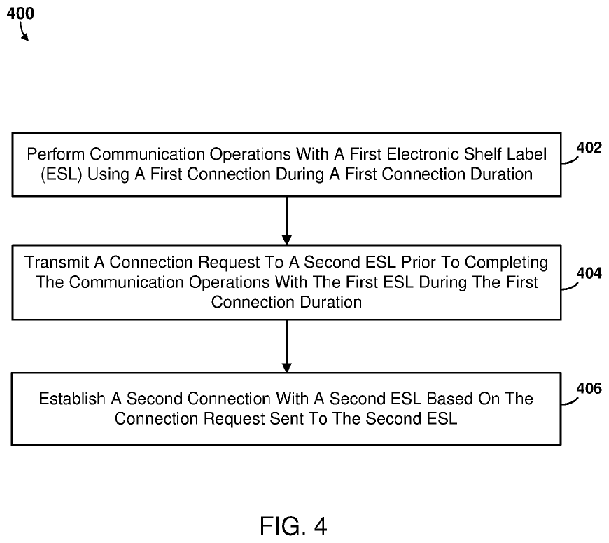

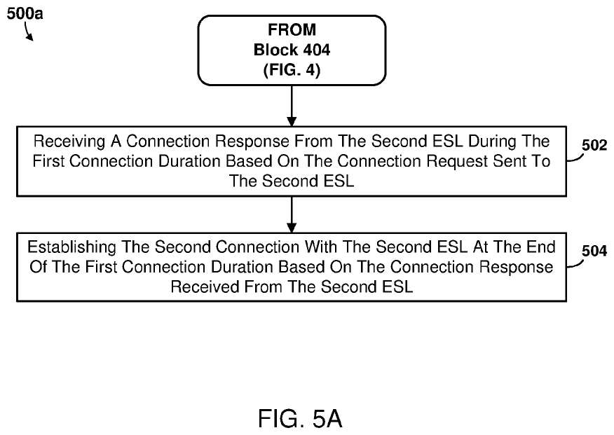

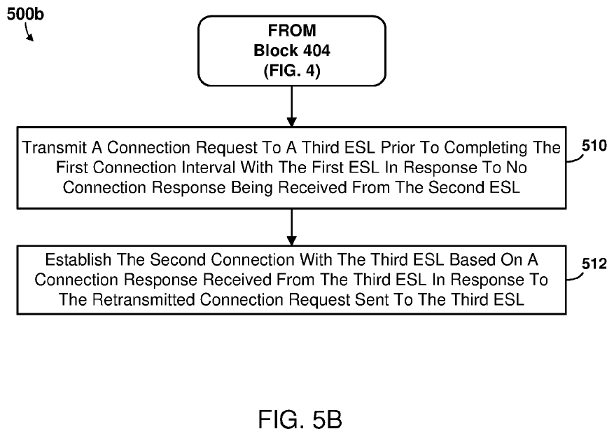

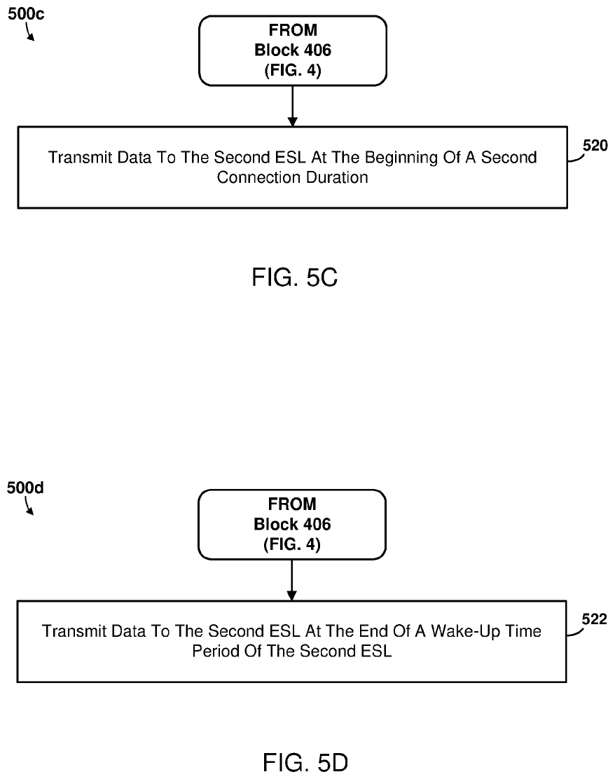

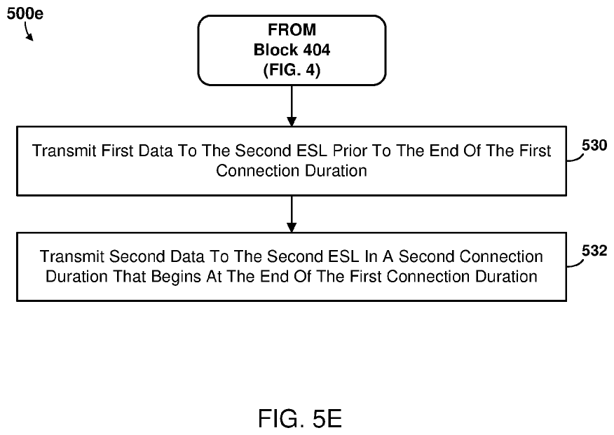

FIG. 4 is a process flow diagram of a method 400 of managing timing of establishing communication links with ESLs according to various embodiments. With reference to FIGS. 1A-4, means for performing each of the operations of the method 400 may include a processor (e.g., 210, 212, 214, 216, 218, 252, 260, 702, and/or 704) and/or a transceiver (e.g., 717) of an AP (e.g., 130, 306) and the like.

In block 402, the processor may perform communication operations with a first electronic shelf label (ESL) using a first connection during a first connection duration. For example, the processor may perform communication operations with the first ESL 310 during the first connection duration 314.

In block 404, the processor may transmit a connection request to a second ESL prior to completing the communication operations with the first ESL during the first connection duration. For example, the processor may send one or more communication requests 302 to the second ESL during the first connection duration 314. In some embodiments, the processor may transmit the connection request to the second ESL in a subevent during the first connection duration in which the second ESL receives a synchronization signal from the AP. In some embodiments, the processor may transmit the connection request to the second ESL at an offset time prior to the completion of the first connection, with the offset time being a time interval that is based on (e.g., at least as long as) a wake-up time period of the second ESL.

In block 406, the processor may establish a second connection with a second ESL based on the connection request sent to the second ESL. In some embodiments, the processor may establish the second connection with the second ESL in a second connection duration that begins at the end of the first connection duration. For example, the processor may establish the second connection 312 with the second ESL in the second connection duration 316 that begins at the end of the first connection duration 314.

FIG. 5A is a process flow diagram of operations 500a that may be performed as part of the method 400 of managing timing of establishing communication links with ESLs according to various embodiments. With reference to FIGS. 1A-5A, means for performing each of the operations 500a may include a processor (e.g., 210, 212, 214, 216, 218, 252, 260, 702, and/or 704) and/or a transceiver (e.g., 717) of an AP (e.g., 130, 306) and the like.

Following performance of the operations of block 404 of the method 400 as described, the processor may receive a connection response from the second ESL during the first connection duration based on the connection request sent to the second ESL in block 502. For example, the processor may receive a connection response from the second ESL (ESL B) during the first connection duration 314 based on the one or more connection requests 302 sent by the AP to the second ESL.

In block 504, the processor may establish the second connection with the second ESL at the end of the first connection duration based on the connection response received from the second ESL. For example, the processor may establish the second connection 312 with the second ESL based on the connection response received by the AP from the second ESL.

FIG. 5B is a process flow diagram of operations 500b that may be performed as part of the method 400 of managing timing of establishing communication links with ESLs according to various embodiments. With reference to FIGS. 1A-5B, means for performing each of the operations 500b may include a processor (e.g., 210, 212, 214, 216, 218, 252, 260, 702, and/or 704) and/or a transceiver (e.g., 717) of an AP (e.g., 130, 306) and the like.

Following performance of the operations of block 404 of the method 400 as described, the processor may transmit the connection request to a third ESL prior to completion of the first connection duration with the first ESL in response to no connection response being received from the second ESL in block 510. For example, the processor may transmit a second connection request 302b, a third connection request 302c, and so forth, to another ESL (a third ESL) in response to not receiving a connection response from the second ESL.

In block 512, the processor may establish the second connection with the third ESL based on a connection response received from the third ESL in response to the connection request transmitted to the second ESL. For example, based on a connection response received from the third ESL in response to the second connection request 302b (or the third connection request 302c, etc.), the processor may establish the second connection 312 with the third ESL at the beginning of the second connection duration 316.

FIG. 5C is a process flow diagram of operations 500c that may be performed as part of the method 400 of managing timing of establishing communication links with ESLs according to various embodiments. With reference to FIGS. 1A-5C, means for performing each of the operations 500c may include a processor (e.g., 210, 212, 214, 216, 218, 252, 260, 702, and/or 704) and/or a transceiver (e.g., 717) of an AP (e.g., 130, 306) and the like.

Following performance of the operations of block 406 of the method 400 as described, the processor may transmit data to the second ESL at the beginning of a second connection duration in block 520. For example, the processor may transmit data 304g to the second ESL at the beginning of the second connection duration 316.

FIG. 5D is a process flow diagram of operations 500d that may be performed as part of the method 400 of managing timing of establishing communication links with ESLs according to various embodiments. With reference to FIGS. 1A-5D, means for performing each of the operations 500d may include a processor (e.g., 210, 212, 214, 216, 218, 252, 260, 702, and/or 704) and/or a transceiver (e.g., 717) of an AP (e.g., 130, 306) and the like.

Following performance of the operations of block 406 of the method 400 as described, the processor may transmit data to the second ESL at the end of a wake-up time period of the second ESL in block 522. For example, the processor may transmit data 304g, 304h to the second ESL beginning at the end of the offset time 320. As noted above, in some embodiments, the end of the offset time 320 also may be the beginning of the second connection duration 316.

FIG. 5E is a process flow diagram of operations 500e that may be performed as part of the method 400 of managing timing of establishing communication links with ESLs according to various embodiments. With reference to FIGS. 1A-5E, means for performing each of the operations 500e may include a processor (e.g., 210, 212, 214, 216, 218, 252, 260, 702, and/or 704) and/or a transceiver (e.g., 717) of an AP (e.g., 130, 306) and the like.

Following performance of the operations of block 404 of the method 400 as described, the processor may transmit first data to the second ESL prior to the end of the first connection duration in block 530. In some embodiments, the processor may transmit the first data to the second ESL during a wake-up time period of the second ESL prior to the end of the first connection duration. For example, the processor may transmit the first data 330a to the second ESL prior to the end of the first connection duration 314.

In block 532, the processor may transmit second data to the second ESL in a second connection duration that begins at the end of the first connection duration. For example, the processor may transmit the second data 330b to the second ESL in the second connection duration 316, which may begin at the end of the first connection duration 314.

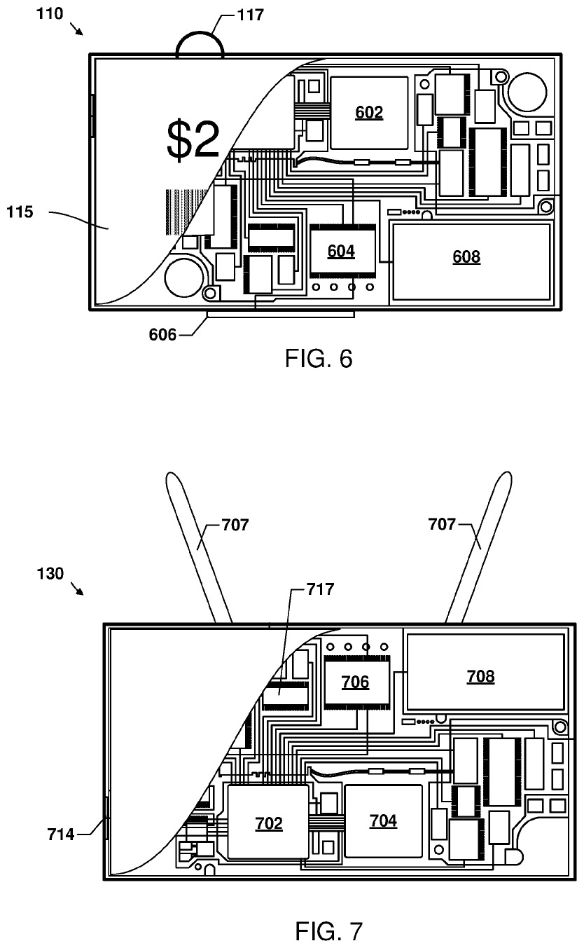

FIG. 6 is a component block diagram of an example of an ESL 110 suitable for use with various embodiments. With reference to FIGS. 1A-6, an ESL 110 may include a display 115 and an illuminator 117 (e.g., an LED or other type of visible indicator) that our coupled to a processor 602 that is configured with processor-executable instructions configured to cause the processor to perform operations of various embodiments. The processor 602 may be coupled to a wireless transceiver 604, such as a BLE transceiver or a combination BLE and Wi-Fi transceiver, that is coupled to an antenna 606 for sending and receiving radio frequency (RF) signals as described herein. In various embodiments, the processor 602 may include an SOC (e.g., 202, 204). An ESL 110 may be powered by a battery 608, freeing the display from having to be connected to a wired power supply. Alternatively, the ESL 110 may be powered from an external source.

FIG. 7 is a component block diagram of an AP 130 suitable for use with various embodiments. With reference to FIGS. 1A-7, the AP 130 may typically include a processor 702, 704 coupled to volatile memory 706 and optionally a larger capacity nonvolatile memory 708. The AP 130 may also include a peripheral memory access device, such as a flash drive, coupled to the processor 702, 704. The AP 130 may also include network access ports 714 (or interfaces) coupled to the processor 702, 704 for establishing data connections with a network, such as the Internet and/or a local area network coupled to other system computers and servers. The AP 130 may include additional access ports, such as USB, Firewire, Thunderbolt, and the like for coupling to peripherals, external memory, or other devices. The AP 130 may include one or more antennas 707 coupled to a transceiver 717 for sending (i.e., transmitting) and receiving electromagnetic radiation that may be connected to a wireless communication link.

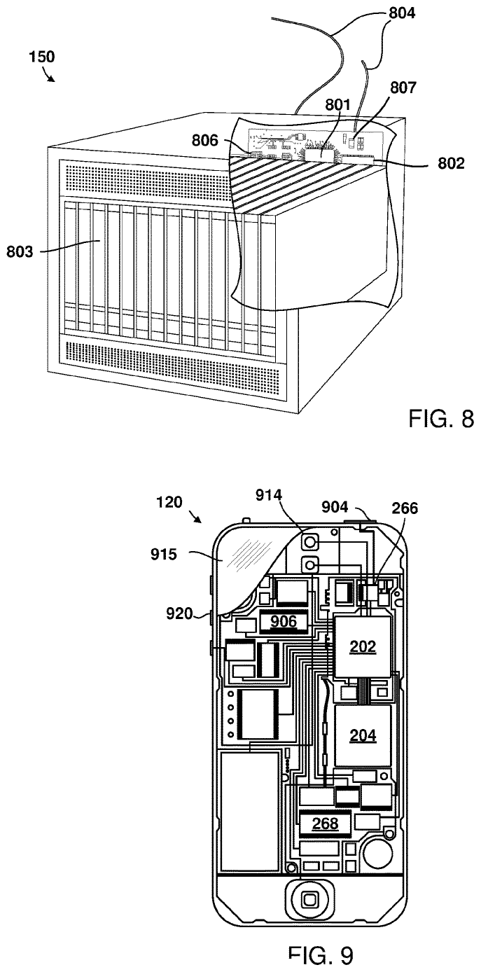

FIG. 8 is a component block diagram of a store management entity server 150 suitable for use with various embodiments. With reference to FIGS. 1A-8, the store management entity server 150 may typically include a processor 801 coupled to volatile memory 802 and a large capacity nonvolatile memory, such as a disk drive 803. The store management entity server 150 may also include a peripheral memory access device, such as a floppy disc drive, compact disc (CD) or digital video disc (DVD) drive 806 coupled to the processor 801. The store management entity server 150 may also include network access ports 804 (or interfaces) coupled to the processor 801 for establishing data connections with a network, such as the Internet and/or a local area network coupled to other system computers and servers. The store management entity server 150 may include one or more antennas 807 for sending and receiving electromagnetic radiation that may be connected to a wireless communication link. The store management entity server 150 may include additional access ports, such as USB, Firewire, Thunderbolt, and the like for coupling to peripherals, external memory, or other devices.

FIG. 9 is a component block diagram of a user mobile device 120 suitable for use as a user mobile device or a consumer user equipment (UE) when configured with processor executable instructions to perform operations of various embodiments. With reference to FIGS. 1A-9, the user mobile device 120 may include a first SOC 202 (e.g., a SOC-CPU) coupled to a second SOC 204 (e.g., a 5G capable SOC). The first and second SOCs 202, 204 may be coupled to internal memory 906, a display 915, and to a speaker 914. Additionally, the user mobile device 120 may include an antenna 904 for sending and receiving electromagnetic radiation that may be connected to a radio module 266 configured to support wireless local area network data links (e.g., BLE, Wi-Fi, etc.) and/or wireless wide area networks (e.g., cellular telephone networks) coupled to one or more processors in the first and/or second SOCs 202, 204. The user mobile device 120 typically also include menu selection buttons 920 for receiving user inputs.

A typical user mobile device 120 may also include an inertial measurement unit (IMU) 268 that includes a number of micro-electromechanical sensor (MEMS) elements configured to sense accelerations and rotations associated movements of the device, and provide such movement information to the first SOC 202. Also, one or more of the processors in the first and second SOCs 202, 204, wireless transceiver 266 may include a digital signal processor (DSP) circuit (not shown separately).

In some embodiments, a user mobile device 120 may be used as a moving AP to diagnose ESLs that have issues establishing communication with the APs or other fixed infrastructure. For example, the user mobile device 120 may be repurposed by the store management entity server by configuring the user mobile device 120 with AP protocols so that the user mobile device 120 may be recognized by ESL as an AP.

The processors of ESLs 110, the user mobile device 120, and the store management entity server 150 may be any programmable microprocessor, microcomputer or multiple processor chip or chips that can be configured by software instructions (applications) to perform a variety of functions, including the functions of various embodiments described herein. In some user mobile devices, multiple processors may be provided, such as one processor within an SOC 204 dedicated to wireless communication functions and one processor within an SOC 202 dedicated to running other applications. Typically, software applications may be stored in the memory 906 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods and operations 300a-300c, 400, and 500a-500e may be substituted for or combined with one or more operations of the methods and operations 300a-300c, 400, and 500a-500e.

Implementation examples are described in the following paragraphs. While some of the following implementation examples are described in terms of example methods, further example implementations may include: the example methods discussed in the following paragraphs implemented by an AP including a processor configured to perform operations of the example methods; the example methods discussed in the following paragraphs implemented by an AP including means for performing functions of the example methods; the example methods discussed in the following paragraphs implemented in a processor used in an AP that is configured to perform the operations of the example methods; and the example methods discussed in the following paragraphs implemented as a non-transitory processor-readable storage medium having stored thereon processor-executable instructions configured to cause a processor of an AP to perform the operations of the example methods.

Example 1. A method performed by a processor of an access point (AP), including performing communication operations with a first electronic shelf label (ESL) using a first connection during a first connection duration, transmitting a connection request to a second ESL prior to completing the communication operations with the first ESL during the first connection duration, and establishing a second connection with the second ESL based on the connection request sent to the second ESL.

Example 2. The method of example 1, in which establishing the second connection with the second ESL based on the connection request sent to the second ESL includes establishing the second connection with the second ESL in a second connection duration that begins at an end of the first connection duration.

Example 3. The method of either of examples 1 and 2, in which transmitting the connection request to the second ESL prior to completing the communication operations with the first ESL during the first connection duration includes transmitting the connection request to the second ESL in a subevent during the first connection duration in which the second ESL receives a synchronization signal from the AP.

Example 4. The method of any of examples 1-3, in which transmitting the connection request to the second ESL prior to completing the first connection duration with the first ESL includes transmitting the connection request to the second ESL at an offset time prior to completion of the first connection, in which the offset time includes a time interval based on a wake-up time period of the second ESL.

Example 5. The method of any of examples 1-4, in which establishing the second connection with the second ESL based on the connection request sent to the second ESL includes receiving a connection response from the second ESL during the first connection duration based on the connection request sent to the second ESL, and establishing the second connection with the second ESL at an end of the first connection duration based on the connection response received from the second ESL.

Example 6. The method of any of examples 1-5, further including transmitting a connection request to a third ESL prior to completion of the first connection duration with the first ESL in response to no connection response being received from the second ESL, and establishing the second connection with the third ESL based on a connection response received from the third ESL in response to the connection request transmitted to the third ESL.

Example 7. The method of any of examples 1-6, further including transmitting data to the second ESL at the beginning of a second connection duration.

Example 8. The method of any of examples 1-7, further including transmitting data to the second ESL at an end of a wake-up time period of the second ESL.

Example 9. The method of any of examples 1-8, in which establishing the second connection with the second ESL based on the connection request sent to the second ESL includes transmitting first data to the second ESL prior to an end of the first connection duration, the method further including transmitting second data to the second ESL in a second connection duration that begins at the end of the first connection duration.

Example 10. The method of example 9, in which transmitting the first data to the second ESL prior to the end of the first connection duration includes transmitting the first data to the second ESL after a wake-up time period of the second ESL that ends prior to the end of the first connection duration.

A number of different cellular and mobile communication services and standards are available or contemplated in the future, all of which may implement and benefit from various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iDEN), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method performed by a processor of an access point (AP), comprising:
performing communication operations with a first electronic shelf label (ESL) using a first connection during a first connection duration;
transmitting a connection request to a second ESL prior to completing the communication operations with the first ESL during the first connection duration; and
establishing a second connection with the second ESL based on the connection request sent to the second ESL.

2. The method of claim 1, wherein establishing the second connection with the second ESL based on the connection request sent to the second ESL comprises establishing the second connection with the second ESL in a second connection duration that begins at an end of the first connection duration.

3. The method of claim 1, wherein transmitting the connection request to the second ESL prior to completing the communication operations with the first ESL during the first connection duration comprises transmitting the connection request to the second ESL in a subevent during the first connection duration in which the second ESL receives a synchronization signal from the AP.

4. The method of claim 1, wherein transmitting the connection request to the second ESL prior to completing the first connection duration with the first ESL comprises transmitting the connection request to the second ESL at an offset time prior to completion of the first connection, wherein the offset time comprises a time interval based on a wake-up time period of the second ESL.

5. The method of claim 1, wherein establishing the second connection with the second ESL based on the connection request sent to the second ESL comprises:
receiving a connection response from the second ESL during the first connection duration based on the connection request sent to the second ESL; and
establishing the second connection with the second ESL at an end of the first connection duration based on the connection response received from the second ESL.

6. The method of claim 1, further comprising:
transmitting a connection request to a third ESL prior to completion of the first connection duration with the first ESL in response to no connection response being received from the second ESL; and
establishing the second connection with the third ESL based on a connection response received from the third ESL in response to the connection request transmitted to the third ESL.

7. The method of claim 1, further comprising transmitting data to the second ESL at the beginning of a second connection duration.

8. The method of claim 1, further comprising transmitting data to the second ESL at an end of a wake-up time period of the second ESL.

9. The method of claim 1, wherein establishing the second connection with the second ESL based on the connection request sent to the second ESL comprises transmitting first data to the second ESL prior to an end of the first connection duration, the method further comprising transmitting second data to the second ESL in a second connection duration that begins at the end of the first connection duration.

10. The method of claim 9, wherein transmitting the first data to the second ESL prior to the end of the first connection duration comprises transmitting the first data to the second ESL after a wake-up time period of the second ESL that ends prior to the end of the first connection duration.

11. An access point (AP), comprising:
a transceiver; and
a processor coupled to the transceiver and comprising firmware (FW) configured to:
perform communication operations with a first electronic shelf label (ESL) using a first connection during a first connection duration;
transmit a connection request to a second ESL prior to completing the communication operations with the first ESL during the first connection duration; and
establish a second connection with the second ESL based on the connection request sent to the second ESL.

12. The AP of claim 11, wherein the processor is further configured to establish the second connection with the second ESL in a second connection duration that begins at an end of the first connection duration.

13. The AP of claim 11, wherein the processor is further configured to transmit the connection request to the second ESL in a subevent during the first connection duration in which the second ESL receives a synchronization signal from the AP.

14. The AP of claim 11, wherein the processor is further configured to transmit the connection request to the second ESL at an offset time prior to completion of the first connection, wherein the offset time comprises a time interval based on a wake-up time period of the second ESL.

15. The AP of claim 11, wherein the processor is further configured to:
receive a connection response from the second ESL during the first connection duration based on the connection request sent to the second ESL; and
establish the second connection with the second ESL at an end of the first connection duration based on the connection response received from the second ESL.

16. The AP of claim 11, wherein the processor is further configured to:
transmit a connection request to a third ESL prior to completion of the first connection duration with the first ESL in response to no connection response being received from the second ESL; and
establish the second connection with the third ESL based on a connection response received from the third ESL in response to the connection request transmitted to the third ESL.

17. The AP of claim 11, wherein the processor is further configured to transmit data to the second ESL at the beginning of a second connection duration.

18. The AP of claim 11, wherein the processor is further configured to transmit data to the second ESL at an end of a wake-up time period of the second ESL.

19. The AP of claim 11, wherein the processor is further configured to:
transmit first data to the second ESL prior to an end of the first connection duration; and
transmit second data to the second ESL in a second connection duration that begins at the end of the first connection duration.

20. The AP of claim 19, wherein the processor is further configured to transmit the first data to the second ESL after a wake-up time period of the second ESL that ends prior to the end of the first connection duration.

21. (canceled)

22. (canceled)

23. (canceled)

24. (canceled)

25. (canceled)

26. (canceled)

27. (canceled)

28. (canceled)

29. (canceled)

30. (canceled)
